(19) United States
(12) Patent Application Publication
(10) Pub. No.: US 2019/0205491 A1
(43) Pub. Date: Jul. 4, 2019

(54) METHOD AND APPARATUS OF EMULATION TECHNIQUES FOR ENHANCED FPGA VALIDATION

(71) Applicant: RAYTHEON COMPANY, Waltham, MA (US)

(72) Inventors: Michael Castle, Long Beach, CA (US); Paul Yue, Granada Hills, CA (US); PC Chien, Walnut, CA (US); Lauren Hack, McKinney, TX (US); Gabriel Andrew Chow, Walnut, CA (US)

(21) Appl. No.: 16/232,583

(22) Filed: Dec. 26, 2018

Related U.S. Application Data
(60) Provisional application No. 62/611,071, filed on Dec. 28, 2017.

(51) Int. Cl. G06F 17/50

(52) U.S. Cl. CPC G06F 17/5027; G06F 17/504

(57) ABSTRACT

A method for modeling a field-programmable gate array (FPGA) for an emulator includes performing a validation process on an FPGA design to determine whether an FPGA emulator is able to emulate at least one component in the FPGA design; responsive to the FPGA emulator being unable to emulate the at least one component in the FPGA design, modifying the FPGA design by replacing the at least one component with at least one replacement component; executing a first simulation of the FPGA design to generate a first output; executing a second simulation of the modified FPGA design to generate a second output; and determining, with reference to the first output and the second output, that the FPGA design and the modified FPGA design are functionally equivalent.

### CROSS REFERENCE TO RELATED APPLICATION

This application claims priority under 35 U.S.C. § 119(e) to U.S. Provisional Application Ser. No. 62/611,071, titled “METHOD AND APPARATUS OF EMULATION TECHNIQUES FOR ENHANCED FPGA VALIDATION,” filed Dec. 28, 2017, which is incorporated herein by reference in its entirety.

### BACKGROUND

### Applicable Field

The field relates generally to emulation environments for validating circuit designs.

### Background

Emulation environments offer immense speedup in performing tasks such as validation of application-specific integrated circuit (ASIC) hardware designs. Designs are developed and validated via emulation, or by using field programmable gate arrays (FPGAs). An emulation model may be based on a hardware description language (HDL) code, which is compiled and executed by the emulation system. The goal is normally debugging and functional verification of the system being designed. Emulation is often used for ASIC, DSP Core and general register-transfer level (RTL) validation.

Due to their relatively low cost and flexibility, FPGAs are being used more and more frequently as an end solution in their own right. An FPGA solution may be employed where the cost of ASIC development is unattractive or prohibitive, such as in a situation where only a limited number of products are being manufactured.

A major drawback of FPGAs is that non-synthesizable components, such as analog components or proprietary Intellectual Property (IP) core, cannot be emulated. FPGA developers are therefore currently faced with a choice of performing a much longer validation process (e.g., simulation) that may take days to process and review a few seconds' worth of data, or of manually adapting the design to be synthesizable for emulation. Because issues may not appear until seconds or minutes into signal data, it may not be feasible to perform a simulation on data from a long enough period to detect such issues. By way of example, a 10 ms throughput may take 30 hours to simulate; by comparison, the same amount of throughput may be executed by an emulator on a scale closer to 10 seconds.

Developers may also run emulations of subsystems or portions of a processor not containing any non-synthesizable components. Yet such partial or piecemeal emulation still allows errors to occur in the absence of a holistic validation. For example, many FPGA applications integrate one or more interfaces that typically operate simultaneously, often introducing complexity to requirement validation due to the institution of corner cases. In addition to interfaces, end-to-end simulations exercising the full data path are often left to FPGA emulation, because validation times increase exponentially with respect to simulation time. A simple module such as I2C can introduce several corner cases—for instance, a CPU reading an I2C register and using the data to compute a calculation to modify the coefficients of an FIR filter. To verify such corner cases, simultaneous stimuli (and monitoring) of all interfaces and the CPU is required. In most test benches this is handled in a highly unstructured, ad-hoc manner. Integration of various verification methodologies, such as OVM, UVM, UVVM, and UVMF, attempt to handle these issues by organizing test structures for ease of reuse and attempt to reduce corner case testing with enhanced reuse verification. It can be difficult to determine when validation is complete.

### SUMMARY

For the above reasons, it would be advantageous to have systems and methods for automatically modifying an FPGA design to replace non-synthesizable components with synthesizable components. Presently disclosed embodiments accordingly modify FPGA designs by replacing non-synthesizable components with software components that are functionally equivalent in relevant ways. The modified FPGA is composed of synthesizable components, allowing it to undergo emulation validation.

According to one aspect, A method for modeling a field-programmable gate array (FPGA) for an emulator is provided. The method includes performing a validation process on an FPGA design to determine whether an FPGA emulator is able to emulate at least one component in the FPGA design; responsive to the FPGA emulator being unable to emulate the at least one component in the FPGA design, modifying the FPGA design by replacing the at least one component with at least one replacement component; executing a first simulation of the FPGA design to generate a first output; executing a second simulation of the modified FPGA design to generate a second output; and determining, with reference to the first output and the second output, that the FPGA design and the modified FPGA design are functionally equivalent.

According to one embodiment, the method further includes executing a first emulation of the modified FPGA design to generate a third output; and determining, with reference to the third output and at least one of the first output and the second output, that the FPGA design and the modified FPGA design are functionally equivalent. According to another embodiment, the at least one component is at least one analog component, and modifying the FPGA design includes replacing the at least one analog component with at least one digital component.

According to one embodiment, the at least one component is at least one block of non-synthesizable logic, and modifying the FPGA design includes replacing the at least one block of non-synthesizable logic with at least block of synthesizable logic. According to a further embodiment, the at least one block of non-synthesizable logic is a semiconductor intellectual property core. According to another embodiment, replacing the at least one block of non-synthesizable logic includes determining an identifier of the at least one block of non-synthesizable logic; and identifying, with reference to the identifier, that the at least one block of synthesizable logic is functionally equivalent to the at least one block of non-synthesizable logic.

According to one embodiment, the at least one component is at least one block of non-synthesizable logic, and performing the validation process on the FPGA design includes executing the at least one block of non-synthesizable logic; and monitoring the execution of the at least one block of non-synthesizable logic for an error condition.

According to another aspect, a computer system includes a processor; and a memory communicatively coupled to the processor and comprising instructions that when executed by the processor causes the processor to perform a validation process on an FPGA design to determine whether an FPGA emulator is able to emulate at least one component in the FPGA design; responsive to the FPGA emulator being unable to emulate the at least one component in the FPGA design, modify the FPGA design by replacing the at least one component with at least one replacement component; execute a first simulation of the FPGA design to generate a first output; execute a second simulation of the modified FPGA design to generate a second output; and determine, with reference to the first output and the second output, that the FPGA design and the modified FPGA design are functionally equivalent.

According to one embodiment, the instructions further cause the processor to execute a first emulation of the modified FPGA design to generate a third output; and determine, with reference to the third output and at least one of the first output and the second output, that the FPGA design and the modified FPGA design are functionally equivalent.

According to another embodiment, the at least one component is at least one analog component, and the instructions further cause the processor to modify the FPGA design by performing acts including replacing the at least one analog component with at least one digital component.

According to yet another embodiment, the at least one component is at least one block of non-synthesizable logic, and the instructions further cause the processor to modify the FPGA design by replacing the at least one block of non-synthesizable logic with at least one block of synthesizable logic. According to a further embodiment, the instructions further cause the processor to replace the at least one block of non-synthesizable logic by performing acts including determining an identifier of the at least one block of non-synthesizable logic; and identifying, with reference to the identifier, that the at least one block of synthesizable logic is functionally equivalent to the at least one block of non-synthesizable logic.

According to another embodiment, the at least one component is at least one block of non-synthesizable logic, and the instructions further cause the processor to perform the validation process on the FPGA design by performing acts including executing the at least one block of non-synthesizable logic; and monitoring the execution of the at least one block of non-synthesizable logic for an error condition.

According to another aspect, a non-transitory computer-readable medium is provided having stored thereon computer-executable instructions that, when executed by one or more processors, cause the one or more processors to perform a validation process on an FPGA design to determine whether an FPGA emulator is able to emulate at least one component in the FPGA design; responsive to the FPGA emulator being unable to emulate the at least one component in the FPGA design, modify the FPGA design by replacing the at least one component with at least one replacement component; execute a first simulation of the FPGA design to generate a first output; execute a second simulation of the modified FPGA design to generate a second output; and determine, with reference to the first output and the second output, that the FPGA design and the modified FPGA design are functionally equivalent.

According to one embodiment, the computer-executable instructions further cause the one or more processors to execute a first emulation of the modified FPGA design to generate a third output; and determine, with reference to the third output and at least one of the first output and the second output, that the FPGA design and the modified FPGA design are functionally equivalent.

According to another embodiment, the computer-executable instructions further cause the one or more processors to modify the FPGA design by performing acts including replacing the at least one analog component with at least one digital component.

According to yet another embodiment, the at least one component is at least one block of non-synthesizable logic, and the computer-executable instructions further cause the one or more processors to modify the FPGA design by replacing the at least one block of non-synthesizable logic with at least one block of synthesizable logic. According to a further embodiment, the at least one block of non-synthesizable logic is a semiconductor intellectual property core. According to still another embodiment, the computer-executable instructions further cause the one or more processors to replace the at least one block of non-synthesizable logic by performing acts including determining an identifier of the at least one block of non-synthesizable logic; and identifying, with reference to the identifier, that the at least one block of synthesizable logic is functionally equivalent to the at least one block of non-synthesizable logic.

According to another embodiment, the at least one component is at least one block of non-synthesizable logic, and the computer-executable instructions further cause the one or more processors to execute instructions that cause the processor to perform the validation process on the FPGA design by performing acts including executing the at least one block of non-synthesizable logic; and monitoring the execution of the at least one block of non-synthesizable logic for an error condition.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “ this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 depicts a process for modeling an FPGA for an emulator according to one embodiment of the present disclosure;

FIG. 2A is a functional block diagram of an FPGA according to one embodiment;

FIG. 2B is a functional block diagram of an FPGA according to one embodiment;

FIG. 3 depicts a process for validating an FPGA for an emulator according to one embodiment of the present disclosure;

FIG. 4 shows an example computer system with which various aspects of the present disclosure may be practiced; and

FIG. 5 shows an example storage system capable of implementing various aspects of the present disclosure.

### DETAILED DESCRIPTION

Present embodiments relate to systems and methods for modeling FPGA designs. In particular, a computer-based method may be performed for analyzing an FPGA design to detect the presence of non-synthesizable components. If non-synthesizable components are detected, the FPGA design is modified to remove or replace those non-synthesizable components with equivalent synthesizable components suitable for emulation. For example, the function of an analog component may be simulated by a software component running on a processor of the FPGA. A code library, database, and/or lookup table may be used to identify the non-synthesizable component, its characteristics, and/or its functionality, and to identify a suitable synthesizable component in the library.

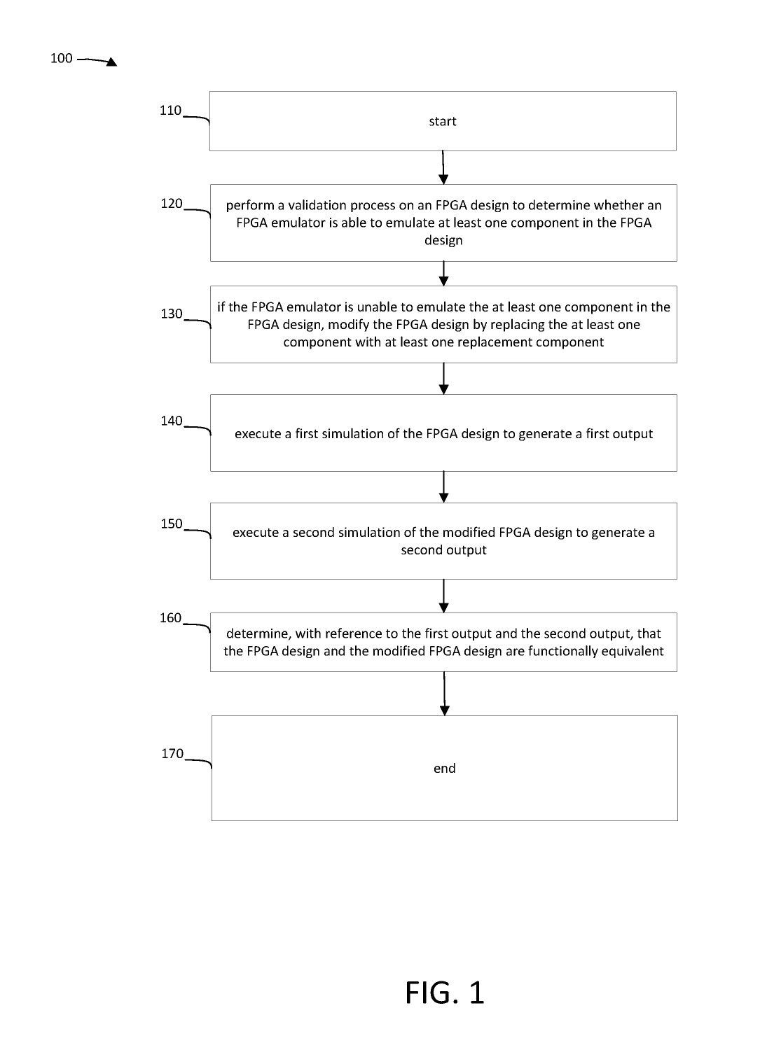

A method 100 for modeling an FPGA for an emulator is shown in FIG. 1.

At step 110, method 100 begins.

At step 120, a validation process is performed on an FPGA design to determine whether an FPGA emulator is able to emulate at least one component in the FPGA design. The FPGA design may be provided in HDL. The HDL may identify the types of components in the FPGA design (including whether they are analog or digital), and may set forth the way(s) in which those components are connected and/or interact. Examples of such components may include phase-locked loops (PLL), analog-to-digital converters (ADC), double-data-rate (DDR) components (e.g., SDRAM), peripheral component interconnect express (PCIe), and serializer/deserializers.

The HDL may also describe any inputs and outputs of the design and/or the subsystems and components from which it is formed, as well as any logic and/or combinatorial functions provided on a signal (or part thereof) intended to pass through the FPGA design.

The HDL may include certain predefined components. In some examples, the predefined components of the HDL may include primitives such as gates, switches, RAM, FIFO, and DSP. In some examples, user-defined primitives (UDPs) may also be allowed. In this manner, the primitive components of the design can be combined in order to model combinatorial logic and sequential logic. Timing information may also be provided in the FPGA design.

The FPGA design may also include logic blocks provided by vendors or other third-parties. Such logic blocks may be proprietary to such third parties, and are referred to here as IP core blocks. The operation of these logic blocks may be “black box,” such that one viewing the FPGA design would not be able to see or access some or all of the individual logic operations performed by the logic block.

During the validation process, components and/or logic blocks not suitable for emulation may be identified. For example, analog components cannot be emulated in the FPGA design flow. Accordingly, any analog components in the FPGA design may be identified and/or flagged for later steps in method 100. Similarly, any non-synthesizable logic block (e.g., IP core blocks) may be identified. Because the logic operations performed by the IP core blocks may not be directly observable, those IP core blocks may also be identified and/or flagged for later steps in method 100.

In some embodiments, the FPGA design may be stepped through along one or more signal paths in order to determine whether an FPGA emulator is able to emulate at least one component in the FPGA design. Each component along the path may be evaluated in this manner. In other embodiments, certain types of components may first be identified as likely candidates for being incompatible with emulation, such as analog components.

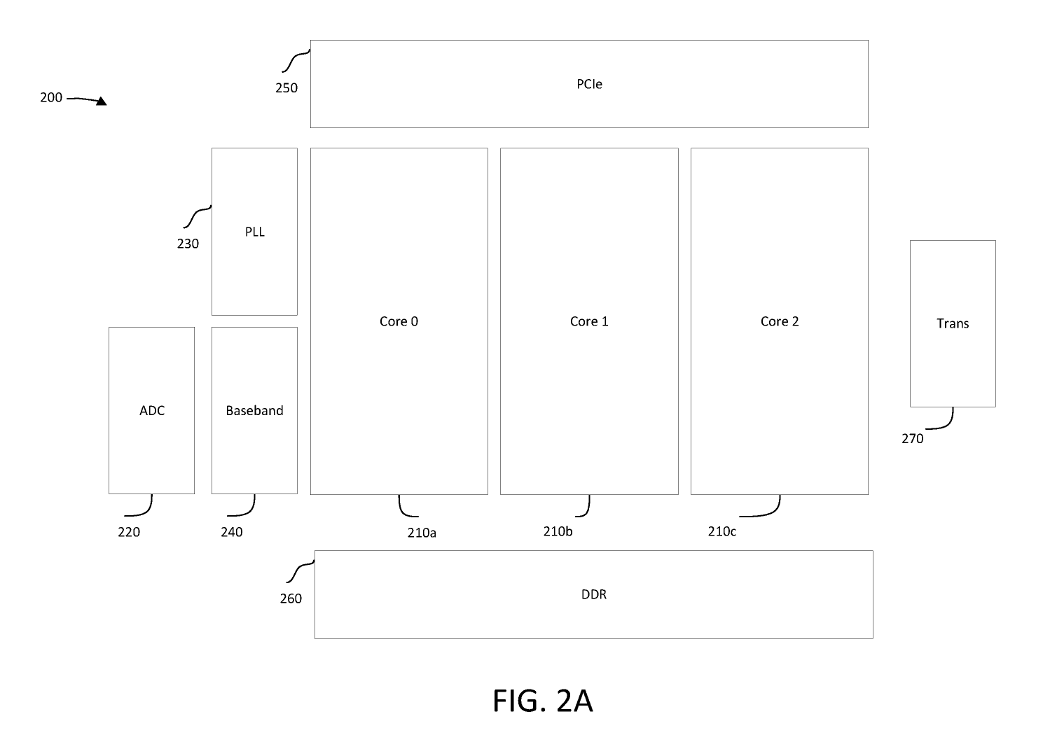

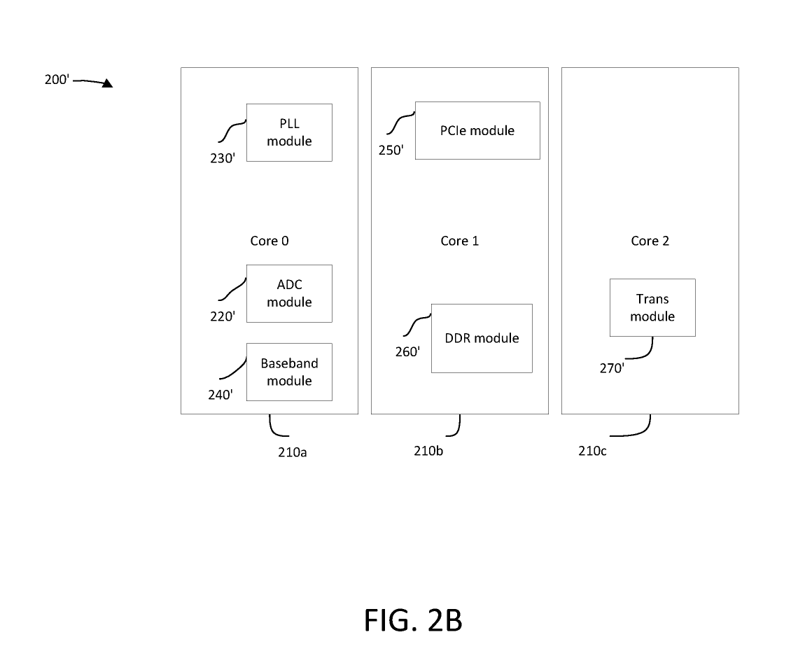

An exemplary block diagram of an FPGA design of a device-under-test (DUT) 200 is shown in FIG. 2A. Such a design may be evaluated in step 120 of FIG. 1, such as by evaluating the underlying HDL code defining the design.

The DUT 200 includes processor cores 210a-c capable of high-speed execution of reprogrammable logic in parallel or serial. The processor cores 210a-c may employ a reduced instruction set computer (RISC) implementation, such as PowerPC, ARM and MIPS. The processor cores 210a-c may be implemented as a soft core, firm core, hard core, or some combination thereof.

A DUT may include a number of components that are non-synthesizable, whether because they are primitives, analog components, or because they are proprietary IP core whose code is unavailable to the entity performing the validation. The DUT 200 shown in FIG. 2A includes a number of non-synthesizable components, including an ADC 220, a PLL 230, a baseband 240, a PCIe interface 250 (for connecting peripheral devices, such as graphic displays or a testbench), a double-data-rate (DDR) component 260 (e.g., SDRAM), and a transmitter 270. Each of these components 220-270 may be identified in step 120 as unable to be emulated in an FPGA emulation as part of a validation flow.

Returning to FIG. 1, at step 130, responsive to the FPGA emulator being unable to emulate the at least one component in the FPGA design, the FPGA design is modified by replacing the at least one component with at least one replacement component.

For example, a primitive (e.g., analog) component that is identified in step 120 may be replaced by a substitute module, logic block, or other substitute component that is compatible with emulation. The substitute module may replicate or approximate the function of the identified component. In some examples, the substitute module may accept the same inputs, and produce the same outputs, as the identified component. In other examples, where the function of the identified component is relatively unimportant or is highly predictable, such that validation of that particular component is not necessary, the substitute module may simply function as a pass-through. The substitute module may imitate the timing or other behavior of the identified component.

The substitute component may be created or determined according to any number of techniques. In one example, the substitute component may be a structured data type in HDL code, and may be customized according to characteristics of the identified component. For example, the substitute component may be created as a UDP or other data structure defined by a user. In another example, the substitute component may be selected from a library of substitute components according to an identification or characteristic of the identified component. For example, if the make and model of the identified component identified in step 120 is known, a lookup table or other facility for identifying a corresponding substitute component in a code library may be provided. The substitute component can then be swapped into the FPGA design in place of the identified component.

In another example, where the identified component is a proprietary IP core of a third party, a code library corresponding to such IP cores may be maintained. In one example, a copy of the actual IP core (or some version thereof) may be maintained. In another example, a simplified version of the IP core may be used, in which the expected inputs and outputs are the same, but the precise functionality of the IP core is not revealed. Such a simplified version of the IP core may allow for testing of corner and edge cases, for example, but may not provide the full functionality of the IP core. In another example, where no substitute copy of the IP core is available, the expected inputs and outputs of the IP core may be examined and a substitute component having the same (or similar) inputs and outputs may be selected.

In some embodiments, a tiered approach to identifying and deploying substitute components may be employed, in which a “best fit” substitute component is used if available; if not, then successive, less optimal solutions may be considered. For example, where a proprietary IP core is identified in step 120, a copy of the proprietary IP core may be searched for in a code library. If no such copy is available, then a prior version of the IP core, or a copy of an IP core for a similar product (either from the same vendor or a different vendor) may be searched for in the code library. If no such alternate version of the IP core is available, but the input/output configuration of the identified component is known or can be determined, then a pass-through module may be created to receive the inputs and output a reasonable value in response, as defined in a lookup table providing inputs and corresponding outputs for desired test values. In this tiered approach, the best emulation-ready design can be generated, but validation is not delayed simply because the most optimal solution is not possible.

FIG. 2B shows a design for a DUT 200′, in which each of the components 220-270 of the DUT 200 shown in FIG. 2A and identified in step 120 have each been replaced in step 130 by a corresponding software module 220′-270′ configured to execute on one of processor cores 210-a-c, and to emulate the performance of the respective components 220-270. For example, an ADS module 220′ has been substituted for ADC 220; a PLL module 230′ has been substituted for PLL 230; a baseband module 240′ has been substituted for baseband 240; a PCIe module 250′ has been substituted for PCIe interface 250; a DDR module 260′ has been substituted for DDR 260; and a transmitter module 270′ has been substituted for transmitter 270. Each of the components 220′-270′ was substituted for the respective identified component 220-270 according to step 130.

It will be appreciated that the example shown in FIG. 2B, in which a one-to-one substitution is employed, is for ease of illustration only. For example, a single module (not shown) may be substituted as a replacement for both ADC 220 and baseband 240 where desired.

Returning to FIG. 1, at step 140, a first simulation of the FPGA design is executed to generate a first output and at step 150, a second simulation of the modified FPGA design is executed to generate a second output.

Simulation of the FPGA may be performed by providing input stimulus, with FPGA simulator software determining the corresponding outputs. These outputs can be examined to validate the FPGA design. Input stimulus may be provided by an interactive waveform editor and/or a testbench, such as a non-synthesizable HDL design that creates a stimulus for the FPGA design. The simulator may be an HDL simulator, such as the ISim simulator offered by Xilinx (San Jose, Calif.) or the ModelSim simulator offered by Mentor Graphics Corporation (Wilsonville, Oreg.).

At step 160, it is determined, with reference to the first output and the second output, that the FPGA design and the modified FPGA design are functionally equivalent.

The output of the simulation of the non-synthesizable FPGA design (i.e., the first output) can be compared to the output of the simulation of the modified (synthesizable) FPGA design (i.e., the second output) on the basis that if the modifications to the FPGA design did not change the function of the design, then the outputs should be identical. By confirming that the outputs match, the modified FPGA design can be validated.

At step 170, method 100 ends.

It will be appreciated that further validation of the modified FPGA design can be performed by comparing the output of an emulation of the FPGA design to the output of the simulation of either the original (non-synthesizable) FPGA design and/or the modified (synthesizable) FPGA design. If all three match, then the modified FPGA design can be validated.

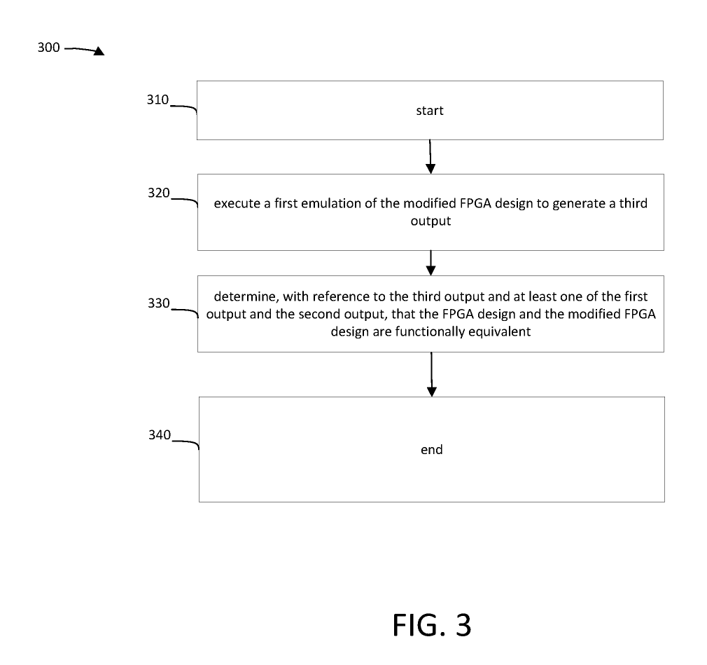

A method 300 for validating the modified FPGA design is shown in FIG. 3.

At step 310, method 300 begins.

At step 320, a first emulation of the modified FPGA design is executed to generate a third output. The HDL defining the FPGA design may be run through a synthesis engine to generate RTL. The output of the synthesis engine is them mapped onto the available pieces of the FPGA architecture. A routing process places and routes signals between the components of the design. The resulting output is a file that can be loaded into a flash memory in order to boot and control operation of the FPGA automatically when powered up.

At step 330, it is determined, with reference to the third output and at least one of the first output and the second output, that the FPGA design and the modified FPGA design are functionally equivalent. This step may be performed in much the same way as in step 160 described above.

At step 340, method 300 ends.

### Example Computer Implementations

Processes described above are merely illustrative embodiments of systems that may be used to model and validate FPGA designs. Such illustrative embodiments are not intended to limit the scope of the present invention, as any of numerous other implementations exist for performing the invention. None of the claims set forth below are intended to be limited to any particular implementation, unless such claim includes a limitation explicitly reciting a particular implementation.

Processes and methods associated with various embodiments, acts thereof and various embodiments and variations of these methods and acts, individually or in combination, may be defined by computer-readable signals tangibly embodied on a computer-readable medium, for example, a non-volatile recording medium, an integrated circuit memory element, or a combination thereof. According to one embodiment, the computer-readable medium may be non-transitory in that the computer-executable instructions may be stored permanently or semi-permanently on the medium. Such signals may define instructions, for example, as part of one or more programs, that, as a result of being executed by a computer, instruct the computer to perform one or more of the methods or acts described herein, and/or various embodiments, variations and combinations thereof. Such instructions may be written in any of a plurality of programming languages, for example, Java, Visual Basic, C, C#, or C++, Fortran, Pascal, Eiffel, Basic, COBOL, etc., or any of a variety of combinations thereof.

The computer-readable medium may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

Some aspects may be implemented as distributed application components that may be executed on a number of different types of systems coupled over a computer network. Some components may be located and executed on mobile devices, servers, tablets, or other system types. Other components of a distributed system may also be used, such as databases or other component types.

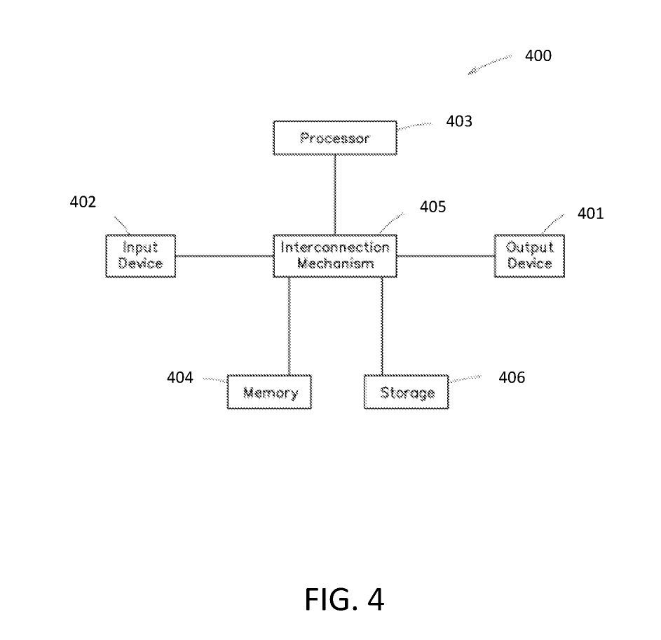

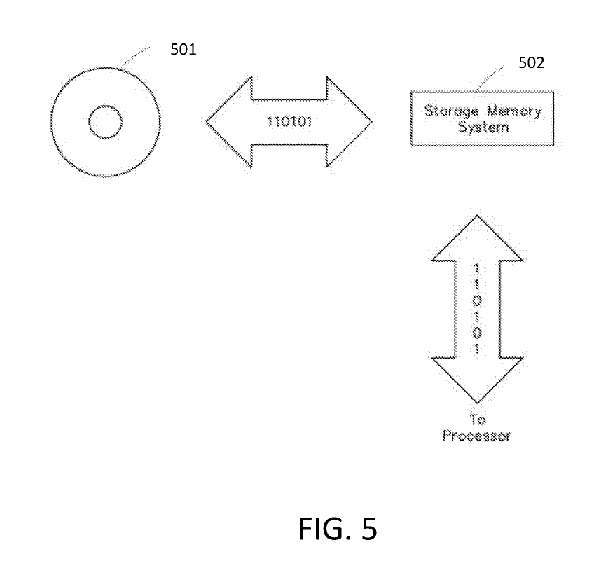

Any number of processes systems of distributed systems may be implemented on a computer system described below in relation to FIGS. 4 and 5. In particular, FIG. 4 shows an example computer system 400 used to implement various aspects. FIG. 5 shows an example storage system 500 that may be used.

System 400 is merely an illustrative embodiment of a computer system suitable for implementing various aspects of the disclosure. Such an illustrative embodiment is not intended to limit the scope of the disclosure, as any of numerous other implementations of the system, for example, are possible and are intended to fall within the scope. For example, a virtual computing platform may be used. None of the claims set forth below are intended to be limited to any particular implementation of the system unless such claim includes a limitation explicitly reciting a particular implementation.

Various embodiments may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to partially or fully automate integration of the security services with the other systems and services according to various embodiments. Further, the software design system may be located on a single computer or may be distributed among a plurality of computers attached by a communications network.

For example, various aspects may be implemented as specialized software executing in a general-purpose computer system 400 such as that shown in FIG. 4. The computer system 400 may include a processor 403 connected to one or more memory devices 404, such as a disk drive, memory, or other device for storing data. Memory 404 is typically used for storing programs and data during operation of the computer system 400. Components of computer system 400 may be coupled by an interconnection mechanism 405, which may include one or more busses (e.g., between components that are integrated within a same machine) and/or a network (e.g., between components that reside on separate discrete machines). The interconnection mechanism 405 enables communications (e.g., data, instructions) to be exchanged between system components of system 400. Computer system 400 also includes one or more input devices 402, for example, a keyboard, mouse, trackball, microphone, touch screen, and one or more output devices 401, for example, a printing device, display screen, and/or speaker. In addition, computer system 400 may contain one or more interfaces (not shown) that connect computer system 400 to a communication network (in addition or as an alternative to the interconnection mechanism 405).

The storage system 406, shown in greater detail in FIG. 5, typically includes a computer readable and writeable nonvolatile recording medium 501 in which signals are stored that define a program to be executed by the processor or information stored on or in the medium 501 to be processed by the program. The medium may, for example, be a disk or flash memory. Typically, in operation, the processor causes data to be read from the nonvolatile recording medium 501 into another memory 502 that allows for faster access to the information by the processor than does the medium 501. This memory 502 is typically a volatile, random access memory such as a dynamic random-access memory (DRAM) or static memory (SRAM). It may be located in storage system 506, as shown, or in memory system 504, not shown. The processor 503 generally manipulates the data within the integrated circuit memory 504, 502 and then copies the data to the medium 501 after processing is completed. A variety of mechanisms are known for managing data movement between the medium 501 and the integrated circuit memory element 504, 502, and the invention is not limited thereto. The invention is not limited to a particular memory system 404 or storage system 406.

The computer system may include specially-programmed, special-purpose hardware, for example, an application-specific integrated circuit (ASIC). Aspects may be implemented in software, hardware or firmware, or any combination thereof. Further, such methods, acts, systems, system elements and components thereof may be implemented as part of the computer system described above or as an independent component.

Although computer system 400 is shown by way of example as one type of computer system upon which various aspects may be practiced, it should be appreciated that aspects are not limited to being implemented on the computer system as shown in FIG. 4. Various aspects may be practiced on one or more computers having a different architecture or components that that shown in FIG. 4.

Computer system 400 may be a general-purpose computer system that is programmable using a high-level computer programming language. Computer system 400 may be also implemented using specially programmed, special purpose hardware. In computer system 400, processor 403 is typically a commercially available processor such as the well-known Pentium, Core, Core Vpro, Xeon, or Itanium class processors available from the Intel Corporation. Many other processors are available. Such a processor usually executes an operating system which may be, for example, the Windows NT, Windows 2000 (Windows ME), Windows XP, Windows Vista or Windows 7 operating systems available from the Microsoft Corporation, MAC OS Snow Leopard, MAC OS X Lion operating systems available from Apple Computer, the Solaris Operating System available from Sun Microsystems, iOS, Blackberry OS, Windows 7 Mobile or Android OS operating systems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects may be distributed among one or more computer systems configured to provide a service (e.g., servers) to one or more client computers, or to perform an overall task as part of a distributed system. For example, various aspects may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects may be implemented in a non-programmed environment (e.g., documents created in HTML, XML or other format that, when viewed in a window of a browser program, render aspects of a graphical-user interface (GUI) or perform other functions). Various aspects may be implemented using various Internet technologies such as, for example, the well-known Common Gateway Interface (CGI) script, PHP Hyper-text Preprocessor (PHP), Active Server Pages (ASP), HyperText Markup Language (HTML), Extensible Markup Language (XML), Java, JavaScript, Asynchronous JavaScript and XML (AJAX), Flash, and other programming methods. Further, various aspects of the present invention may be implemented in a cloud-based computing platform, such as the well-known EC2 platform available commercially from Amazon.com (Seattle, Wash.), among others. Various aspects may be implemented as programmed or non-programmed elements, or any combination thereof.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Embodiments disclosed herein may be combined with other embodiments in any manner consistent with at least one of the principles disclosed herein, and references to “an embodiment,” “some embodiments,” “an alternate embodiment,” “certain embodiments,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment. Further examples and embodiments disclosed herein are not limited in application to the details of construction and the arrangement of components set forth in the foregoing description or illustrated in the accompanying drawings. Various examples are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Accordingly, the foregoing description and drawings are by way of example only.

1. A method for modeling a field-programmable gate array (FPGA) for an emulator comprising:
performing a validation process on an FPGA design to determine whether an FPGA emulator is able to emulate at least one component in the FPGA design;
responsive to the FPGA emulator being unable to emulate the at least one component in the FPGA design, modifying the FPGA design by replacing the at least one component with at least one replacement component;
executing a first simulation of the FPGA design to generate a first output;
executing a second simulation of the modified FPGA design to generate a second output; and
determining, with reference to the first output and the second output, that the FPGA design and the modified FPGA design are functionally equivalent.

2. The method of claim 1, further comprising:
executing a first emulation of the modified FPGA design to generate a third output; and
determining, with reference to the third output and at least one of the first output and the second output, that the FPGA design and the modified FPGA design are functionally equivalent.

3. The method of claim 1, wherein the at least one component is at least one analog component, and wherein modifying the FPGA design comprises replacing the at least one analog component with at least one digital component.

4. The method of claim 1, wherein the at least one component is at least one block of non-synthesizable logic, and wherein modifying the FPGA design comprises replacing the at least one block of non-synthesizable logic with at least block of synthesizable logic.

5. The method of claim 4, wherein the at least one block of non-synthesizable logic is a semiconductor intellectual property core.

6. The method of claim 4, wherein replacing the at least one block of non-synthesizable logic comprises:
determining an identifier of the at least one block of non-synthesizable logic; and
identifying, with reference to the identifier, that the at least one block of synthesizable logic is functionally equivalent to the at least one block of non-synthesizable logic.

7. The method of claim 1, wherein the at least one component is at least one block of non-synthesizable logic, and wherein performing the validation process on the FPGA design comprises:
executing the at least one block of non-synthesizable logic; and
monitoring the execution of the at least one block of non-synthesizable logic for an error condition.

8. A computer system comprising:
a processor; and
a memory communicatively coupled to the processor and comprising instructions that when executed by the processor causes the processor to:
perform a validation process on an FPGA design to determine whether an FPGA emulator is able to emulate at least one component in the FPGA design;
responsive to the FPGA emulator being unable to emulate the at least one component in the FPGA design, modify the FPGA design by replacing the at least one component with at least one replacement component;
execute a first simulation of the FPGA design to generate a first output;
execute a second simulation of the modified FPGA design to generate a second output; and
determine, with reference to the first output and the second output, that the FPGA design and the modified FPGA design are functionally equivalent.

9. The computer system of claim 8, wherein the instructions further cause the processor to:
execute a first emulation of the modified FPGA design to generate a third output; and
determine, with reference to the third output and at least one of the first output and the second output, that the FPGA design and the modified FPGA design are functionally equivalent.

10. The computer system of claim 8, wherein the at least one component is at least one analog component, and wherein the instructions further cause the processor to modify the FPGA design by performing acts comprising replacing the at least one analog component with at least one digital component.

11. The computer system of claim 8, wherein the at least one component is at least one block of non-synthesizable logic, and wherein the instructions further cause the processor to modify the FPGA design by replacing the at least one block of non-synthesizable logic with at least one block of synthesizable logic.

12. The computer system of claim 11, wherein the instructions further cause the processor to replace the at least one block of non-synthesizable logic by performing acts comprising:
determining an identifier of the at least one block of non-synthesizable logic; and
identifying, with reference to the identifier, that the at least one block of synthesizable logic is functionally equivalent to the at least one block of non-synthesizable logic.

13. The computer system of claim 8, wherein the at least one component is at least one block of non-synthesizable logic, and wherein the instructions further cause the processor to perform the validation process on the FPGA design by performing acts comprising:
executing the at least one block of non-synthesizable logic; and
monitoring the execution of the at least one block of non-synthesizable logic for an error condition.

14. A non-transitory computer-readable medium having stored thereon computer-executable instructions that, when executed by one or more processors, cause the one or more processors to:
perform a validation process on an FPGA design to determine whether an FPGA emulator is able to emulate at least one component in the FPGA design;
responsive to the FPGA emulator being unable to emulate the at least one component in the FPGA design, modify the FPGA design by replacing the at least one component with at least one replacement component;
execute a first simulation of the FPGA design to generate a first output;
execute a second simulation of the modified FPGA design to generate a second output; and
determine, with reference to the first output and the second output, that the FPGA design and the modified FPGA design are functionally equivalent.

15. The non-transitory computer-readable medium of claim 14, wherein the computer-executable instructions further cause the one or more processors to:
execute a first emulation of the modified FPGA design to generate a third output; and
determine, with reference to the third output and at least one of the first output and the second output, that the FPGA design and the modified FPGA design are functionally equivalent.

16. The non-transitory computer-readable medium of claim 14, wherein the computer-executable instructions further cause the one or more processors to:
modify the FPGA design by performing acts comprising replacing the at least one analog component with at least one digital component.

17. The non-transitory computer-readable medium of claim 14, wherein the at least one component is at least one block of non-synthesizable logic, and wherein the computer-executable instructions further cause the one or more processors to modify the FPGA design by replacing the at least one block of non-synthesizable logic with at least one block of synthesizable logic.

18. The non-transitory computer-readable medium of claim 17, wherein the at least one block of non-synthesizable logic is a semiconductor intellectual property core.

19. The non-transitory computer-readable medium of claim 17, wherein the computer-executable instructions further cause the one or more processors to replace the at least one block of non-synthesizable logic by performing acts comprising:
determining an identifier of the at least one block of non-synthesizable logic; and
identifying, with reference to the identifier, that the at least one block of synthesizable logic is functionally equivalent to the at least one block of non-synthesizable logic.

20. The non-transitory computer-readable medium of claim 14, wherein the at least one component is at least one block of non-synthesizable logic, and wherein the computer-executable instructions further cause the one or more processors to execute instructions that cause the processor to perform the validation process on the FPGA design by performing acts comprising:
executing the at least one block of non-synthesizable logic; and
monitoring the execution of the at least one block of non-synthesizable logic for an error condition.
